(19) United States
(12) Patent Application Publication
(10) Pub. No.: US 2008/0045431 A1
(43) Pub. Date: Feb. 21, 2008

(54) Method of Removing Laundry Ash

(75) Inventor: Fabio Corradini, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/571,673

(22) PCT Filed: Jul. 8, 2005
(86) PCT No.: PCT/GB05/02681

§ 371 Date: Jan. 12, 2007

(30) Foreign Application Priority Data
Jul. 8, 2004 (GB) 0415291.4

(51) Int. Cl. C11D 7/26; C11D 3/02; C11D 3/20; C11D 7/08

(52) U.S. Cl. 510/362

(57) ABSTRACT

This invention relates to a method of removing and preventing the deposition of hard water scale in a clothes washing machine. In particular the method relates to the removal of and prevention of scale build up after the main wash of a clothes washing machine. The invention involves the addition of a buffered composition of pH 1-6 into the rinse cycle of the clothes washing machine. The invention also relates to water-softening compositions for such methods.

This invention relates to a method of removing and preventing the deposition of hard water scale in a clothes washing machine. In particular the method relates to the removal of and prevention of scale build up after the main wash of a clothes washing machine. The invention also relates to water-softening compositions for such methods.

It is well known that certain metal compounds, notably calcium compounds, when present in water, have a significant effect on the properties of the water. For example, “hard” water containing a significant loading of soluble calcium and magnesium compounds may require a large amount of soap or detergent in order to form a lather. Scale deposits can readily form from such water, for example on heating or pH change or evaporation. These can be incrustations, which are left on a surface that has come into contact with the hard water. Particular issues arise in ware washing machines, such as dish and clothes washing machines. In particular scale incrustations may be left on the surfaces of the machines as well as the items washed therein. In particular issues arise with incrustation of heating elements, which reduced their life span and efficiency. A further issue arises in that scale incrustation can be found on the surface of clothes washed in the clothes washing machines which are perceptible to the wearer as feeling harsh to the touch.

There have been many proposals for removal of metal ions from aqueous solutions. In the industrial context proposals have included filter beds and polymeric filters for capturing heavy metal ions from an aqueous solution flowing within a passageway. Examples are given in EP992238A and GB20869564A. In the domestic context chelating compositions can be added to an aqueous washing solution and these can capture metal ions, such as calcium ions. Examples of chelating compositions are given in EP892040A.

Typically in ware washing machines cleaning compositions are provided which are “built” which provide a water softening effect and an increase to the efficiency of the detergent used therein. However, such compositions are not effective for softening the water in the rinse cycle of ware washing machines since such compositions are pumped out of the machine along with the dirty water prior to the rinse cycle. Therefore, scale deposits may build up on the hard surfaces of the washing machine such as the heating element, as well as the fabric of the items being worked.

We have previously found (WO 3080918) that by providing a water-softening agent to the rinse cycle of a ware-washing machine significant benefits can be found, such as reduction in the amount of incrustation and/or water marks caused during the rinse cycle. In addition we have found benefits on the softness of the fabrics after the wash, a reduction in the degree of shrinkage of the fabrics and a reduction in the amount of wrinkles found on the fabrics after the wash.

Typically, such compositions contain sufficient acidity that they neutralise the alkaline residues from the main wash cycle only. In addition, the Ca²⁺ chelating, ability of the composition typically is to build the Ca²⁺ found in the rinse water.

We have found that by increasing the acidity of the rinse added composition, and by providing a buffer there are surprisingly improved benefits. In particular, existing scale in the machine is removed.

Therefore, we present as a feature of the invention a method of removing and preventing the deposit of limescale in a clothes washing machine, by providing a composition having a pH of at least 1.0, 1.5, 2.0, 2.1, 2.3, 2.5, 2.7, 2.9, 3.1, 3.2, 3.3, 3.5, 3.7, 3.9 or 4.1 and, at most, of 6.0, 5.5, 5.0, 4.5, 4.0, 3.5, 3.0 or 2.9 the composition in addition to the acidifying agent contains a buffer having a pKa of between ±2, ideally ±1.8, 1.6, 1.4, 1.2, 1.0, 0.8, 0.6, of the pH of the composition, preferably to the water of the rinse cycle of the clothes washing machine.

Preferably the method is carried out while the machine is being used for washing clothes. The invention may alternatively be defined as a method of washing clothes, in which the defined method is applied to remove or prevent the deposit of limescale.

We present as a further definition of the present invention a method of removing and/or preventing the deposit of limescale in a clothes washing machine by providing, in the rinse cycle of the machine, a buffered composition having a pH in the range 1 to 6.

Preferably the composition is substantially free from any fabric softening actives, surfactant, and/or bleach. By substantially free we mean <15% wt, <12% wt, <10% wt, <8% wt, <6% wt, <4% wt, <2% wt, <1% wt, <0.5% wt, <0.1% wt, <0.01% wt of each and any combination or all of the ingredients listed above.

A number of different techniques can be envisaged for the delivery of a water-softening agent to a clothes washing machine during the rinse cycle.

A simple technique can be used in a clothes washing machine where the composition is added into the dispensing drawer, usually reserved for the fabric conditioner. Alternatively a “rinse hold” cycle is selected on the clothes washing machine, found on most machines and used so that the user may add bleach to the rinse cycle, and the composition is added directly to the water of the rinse cycle, optionally in addition to a bleaching composition or fabric softening composition.

A more sophisticated technique would be to provide sustained release of the water-softening active through the wash and rinse cycle in a single product. Delayed release of the water-softening agent could be used such that the agent is released during the rinse cycle only, or substantially most of the composition (greater than 50%) is released into the rinse cycle.

Delayed or sustained release can be achieved in several ways.

In a preferred method a water-softening active(s) is/are provided during the main wash cycle, in addition to the method of the invention, applied during the rinse cycle. Preferably the same composition, comprising an acidifying agent and a buffer, is added at both stages.

We present as a feature of the invention a method involving two separate additions of water-softening composition, the additions being

1) into the main wash cycle;

2) into the rinse cycle;

wherein instructions are provided for a user to add water-softening composition to the wash cycle of a clothes-washing machine and to add water-softening composition to the rinse cycle of the clothes washing machine, the same water-softening composition preferably being added in each addition.

The first addition may also comprise a heavy or light duty laundry detergent—but need not do so—but the second addition preferably does not.

Acidity

Preferably the acidifying agent is an organic acid.

Suitable organic acids include citric, acetic, formic, glycolic and oxalic acid. Preferably the acid is a carboxylic acid, more preferably a polycarboxylic acid, most preferably having 2-4 carboxylic groups. Most preferably the acid is citric acid. Alternatively the acidifying agent may be a non-organic acid, for example phosphoric acid, sulphamic or boric acid.

Buffer

Ideally, a pH buffering means is also present. A pH buffering means may be at a level of from 0.1% to 10% by weight. Preferably, from 0.2% to 8% by weight of the total composition of a pH buffering means or a mixture thereof, preferably from 0.3% to 5%, more preferably from 0.3% to 3% and most preferably from 0.3% to 2% wt. Preferably however a pH buffering means is present at a level of from 0.3 to 30% by weight, preferably 5 to 25%, most preferably 10 to 20%.

By “pH buffering means”, it is meant herein any compound which when mixed with another solution of higher pH makes the resulting solution able to resist a decrease in hydrogen ion concentration.

Preferred pH buffering means for use herein comprise an acid having its pKa (if only one) or at least one of its pKa values in the range from 2 to 6.5, preferably from 3 to 5, and its conjugated base.

Preferably the acid buffering means herein consists of the acid as defined herein and a salt thereof at a weight ratio of the acid to its salt (measured in terms of compounds added to form the composition) of preferably 0.1:1 to 10:1, more preferably 0.2:1 to 5:1. Further preferred ratios of acidifying agent:salt are 5:1-2:3, more preferably 2:1-2:3 and especially 1:1-2:3. A highly preferred ratio of the acid to its salt is 1 since this is the best combination to achieve optimum buffering capacity, or slightly lower.

Preferably a given pH buffering means herein will be used to buffer compositions having a pH between pH=pKa −1 and pH=pKa +1 of each of its pKa values.

Suitable pH buffers may be based upon citric, acetic, phosphoric, or boric acid, or any other buffer systems described in literature.

Water Softening Agent

Ideally, a water softening agent is also present (in addition to the acidifying agent and buffer, either or both of which may, depending on their selection, also be a water softening agent). Preferred amounts present of such an (additional) water softening agent are from 5 to 80% wt, preferably 1 to 30% wt, preferably 2 to 20% wt, most preferably 5 to 15% wt.

There are three main types of method of action for water-softening agents, described below.

1) Ion exchange agents—such agents include alkali metal (preferably sodium) aluminosilicates either crystalline, amorphous or a mixture of the two. Such aluminosilicates generally have a calcium ion exchange capacity of at least 50 mg CaO per gram of aluminosilicate, comply with a general formula:
0.8-1.5 Na₂O·Al₂O₃·0.8-6 SiO₂
and incorporate some water. Preferred sodium aluminosilicates within the above formula contain 1.5-3.0 SiO₂units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds are the layered sodium silicate builders, such as are disclosed in U.S. Pat. No. 4,464,839 and U.S. Pat. No. 4,820,439 and also referred to in EP-A-551375.

These materials are defined in U.S. Pat. No. 4,820,439 as being crystalline layered, sodium silicate of the general formula
NaMSiₓO₂ₓ₊₁·YH₂O
wherein

M denotes sodium or hydrogen,

x is from 1.9 to 4 and y is from 0 to 20.

Quoted literature references describing the preparation of such materials include Glastechn. Ber. 37,194-200 (1964), Zeitschrift fur Kristallogr. 129, 396-404 (1969), Bull. Soc. Franc. Min. Crist., 95, 371-382 (1972) and Amer. Mineral, 62, 763-771 (1977). These materials also function to remove calcium and magnesium ions from water, also covered are salts of zinc which have also been shown to be effective water softening agents.

2) Ion capture agents—agents which prevent metal ions from forming insoluble salts or reacting with surfactants, such as polyphosphate, monomeric polycarboxylates, such as citric acid or salts thereof, polycarboxylate polymers, such as polyacrylates, acrylic/maleic copolymers, and acrylic phosphonates, EDTA, algins, alginates.

3) Anti-nucleating agents—agents that prevent seed crystal growth, such as polycarboxylate polymers, such as polyacrylates, acrylic/maleic copolymers, and acrylic phosphonates, and sulfonates. Such polymers may also act as ion capture agents as well.

Preferred organic water-soluble water softening agents which may be present include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates, hydroxyethyliminodiacetates, phosphonates, iminodisuccinates, polyaspartic acids, BHT, phosphonate stabilisers such as, diethylenetriaminepenta (methylene phosphonic acid and its corresponding pentasodium salt) available under the trade names Dequest 2060 and Dequest 2066 Monsanto Chemical Co), DTPMP and DTPMA (Dequest 2010) and HEDP.

Preferably the water-soluble water softening agent is a neutralised or partially neutralised carboxylic acid, such as citric acid, succinic acid or maleic acid, and/or a neutralised or partially neutralised polycarboxylic acid, such as a polyacrylate of MW: 4000-8000 (such as Acusol 445N (Rohm & Haas) CAS REG Nr. 66019-18-9 or Sokalan from BASF).

Thus a preferred composition used in the present invention contains an acidifying agent which is also a water softening agent; and preferably a salt of the acid as the buffer, also a water softening agent.

In this invention the method is used in successive washes, for example at least 10 washes; it is preferably not something which is done as a special cleaning measure.

In accordance with a further aspect of the present invention there is provided a composition as defined herein in relation to the method of the present invention.

The invention will now be described, by way of embodiment, with reference to the following examples.

### EXAMPLES 1-4

Examples 1 to 4 were blends of the ingredients set out in the table below.

| Function | Ingredient | Example 1 | Example 1 | Example 3 | Example 4 |
|---|---|---|---|---|---|
| Acidifying | Citric acid | 6.50 | 8.90 | 11.50 | 10.00 |
| agent | | | | | |
| Buffer | Trisodium citrate | 12.60 | 17.20 | 18.10 | 19.30 |
| | bihydrate | | | | |
| Water | Acusol 445 | 10.20 | 6.50 | 9.80 | 9.50 |
| softening | | | | | |
| polymer | | | | | |
| Thickener | Xanthan gum | 0.09 | 0.14 | 0.10 | 0.15 |
| Stabiliser | IDS | 0.50 | — | 0.40 | 0.40 |
| (chelating) | (imminodisuccinate) | | | | |
| Preservative | Acticide F (N) | 0.10 | 0.15 | 0.10 | 0.10 |
| Minors - | Proprietary | 0.10 | 0.10 | 0.10 | 0.10 |
| dye, perfume | | | | | |
| Solvent | Water | Balance | Balance | Balance | Balance |

The compositions are added into the washing machine both in the main wash cycle (40 ml) and in the rinse cycle (40 ml). Given that the compositions are intended to be used every wash for “keep clean action”, not occasionally for “get clean action”, the test regime was 100 washes of clothes at 60° C. (normal programme). Each composition was found to give excellent performance in giving good water softness and avoiding laundry ash build-up.

### EXAMPLE 5

10 to 30% Citric acid

10 to 35% Trisodium citrate

Others (water, preservative, thickener, perfume, dye)

The results below refer to a formula with 30% citric acid and 10% citrate (pH 2.7, 60 ml dose), 24 wash cycles at 60° C. (normal cotton programme).

Results on Laundry Ash (average of 3 different standard swatches: Empa 221, WFK10A, Honeycomb):

| | |
|---|---|
| Persil Regular | 6.0% |
| Persil Reg. + Calgon Tab | 4.2% |
| Persil Reg. + Rinse Aid | 0.7% |

NB an un-washed swatch would give approx. 0.2-0.5%

| | HE incr. | LA % |
|---|---|---|
| Omo Matik (TK) alone | 850 mg | 6.3% |
| Omo Matik + Calgon Tab | 630 mg | 5.8% |
| Omo Matik + Example 5 | 20 mg | 0.1% |

1. A method of removing and preventing the deposit of limescale in a clothes washing machine by providing a composition having a pH of at least 1.0 and at most 6.0, the composition comprising an acidifying agent and a pH buffer having a pKa of between ±2 of the pH of the composition.

2. A method as claimed in claim 1, wherein the composition additionally comprises a water-softening agent selected from an ion exchange agent or an ion capture agent or an anti-nucleating agent, or a mixture of any thereof, such water-softening agent being additional to the acidifying agent or the pH buffer when the acidifying agent or buffer are themselves a water-softening agent.

3. A method as claimed in claim 1, wherein the composition is in the form of a thickened liquid.

4. A method as claimed in claim 1, wherein the composition is added into the fabric softening dispensing drawer of a clothes washing machine.

5. A method as claimed in claim 1, wherein the composition is added into the rinse cycle of the clothes washing machine.

6. A method as claimed in claim 1, wherein the composition is added into the main wash cycle of the clothes washing machine.

7. A method as claimed in claim 1 wherein the composition is substantially free from a fabric softening active, surfactant and/or a bleach.

8. A method as claimed in claim 1 wherein the acidifying agent is an organic acid, preferably citric acid, acetic acid, formic acid, glycolic acid or oxalic acid, or is boric acid, sulphamic acid, or phosphoric acid.

9. A method as claimed in claim 1 wherein the acidifying agent and buffer are an acid and its conjugate base and in a molar ratio in the range 10:1-0.1:1.

10. A method as claimed in claim 12 wherein the acidifying agent and buffer are present in the molar ratio 1:1-2:3.

11. A composition for removing and/or preventing the deposit of limescale in a clothes washing machine, the composition being a buffered composition of pH in the range 1-6.

12. A method as claimed in claim 9 wherein the acidifying agent and buffer are an acid and its conjugate base and in a molar ratio in the range 5:1-2:3.

13. A method as claimed in claim 2, wherein the composition is in the form of a thickened liquid.

14. A method as claimed in claim 2, wherein the composition is added into the fabric softening dispensing drawer of a clothes washing machine.

15. A method as claimed in claim 2, wherein the composition is added into the rinse cycle of the clothes washing machine.

16. A method as claimed in claim 2, wherein the composition is added into the main wash cycle of the clothes washing machine.

17. A method as claimed in claim 2 wherein the composition is substantially free from a fabric softening active, surfactant and/or a bleach.

18. A method as claimed in claim 2 wherein the acidifying agent is an organic acid, preferably citric acid, acetic acid, formic acid, glycolic acid or oxalic acid, or is boric acid, sulphamic acid, or phosphoric acid.

19. A method as claimed in claim 2 wherein the acidifying agent and buffer are an acid and its conjugate base and in a molar ratio in the range 10:1-0.1:1.

20. A method as claimed in claim 19 wherein the acidifying agent and buffer are an acid and its conjugate base and in a molar ratio in the range 5:1-2:3.
